(19) United States
(12) Patent Application Publication
(10) Pub. No.: US 2023/0417874 A1
(43) Pub. Date: Dec. 28, 2023

(54) APPARATUS FOR PROTECTING A SENSOR

(71) Applicants: HYUNDAI MOTOR COMPANY, Seoul (KR); KIA CORPORATION, Seoul (KR)

(72) Inventor: Eun Sik Kim, Gwangmyeong-si (KR)

(73) Assignees: HYUNDAI MOTOR COMPANY, Seoul (KR); KIA CORPORATION, Seoul (KR)

(21) Appl. No.: 17/980,773

(22) Filed: Nov. 4, 2022

(30) Foreign Application Priority Data
Jun. 28, 2022 (KR) 10-2022-0078939

(51) Int. Cl. G01S 7/481; G01N 21/59; G01S 7/497

(52) U.S. Cl. CPC G01S 7/4813; G01N 21/59; G01S 7/497; G01S 2007/4977

(57) ABSTRACT

An apparatus for protecting a sensor includes an internal cover covering a sensor; an external cover surrounding the internal cover and configured to be stretched and contracted along an external side of the internal cover; and a driving unit connected to the external cover and allowing the external cover to be stretched and contracted.

### CROSS-REFERENCE TO RELATED APPLICATIONS

This application claims benefit of and priority to Korean Patent Application No. 10-2022-0078939, filed on Jun. 28, 2022 in the Korean Intellectual Property Office, the disclosure of which is incorporated herein by reference in its entirety.

### TECHNICAL FIELD

The present disclosure relates to an apparatus for protecting a sensor from foreign substances, which may be attached to a sensing surface of the sensor, in order to maintain cleanliness of the sensing surface.

### BACKGROUND

The statements in this section merely provide background information related to the present disclosure and may not constitute prior art.

In an autonomous vehicle, a large number of sensors such as a lidar, a radar, a camera, and the like are used to enable the vehicle to perform safe autonomous driving. However, in the case in which a sensor is contaminated by foreign substances (e.g., dust, raindrop, debris), accurate sensing may be impossible.

To address the contamination issue, a technique of installing a pump and a wiper around a sensor of a vehicle and wiping foreign substances off by spraying air or water thereon, or removing foreign substances by rotating a protective cover for a sensor has been suggested.

In the case of a technique of wiping off by spraying air or water, the configuration thereof may be complicated, a large layout in a vehicle may be occupied, and the technique may be expensive, which may be disadvantageous to marketability. In particular, in a cylindrically-shaped sensor such as a lidar, it may be difficult to clean the sensor using air or water. Also, in the case of a technique of rotating a protective cover, it may be difficult to properly remove foreign substances when foreign substances with high viscosity are attached thereto.

### SUMMARY

An aspect of the present disclosure is to provide an apparatus for protecting a sensor which may prevent foreign substances from being directly attached to a sensing surface of a sensor and may maintain cleanliness of the sensing surface such that the sensor may sense accurately.

According to an aspect of the present disclosure, an apparatus for protecting a sensor includes an internal cover covering a sensor; an external cover surrounding the internal cover and configured to be stretched and contracted along an external side of the internal cover; and a driving unit connected to the external cover and configured to allow the external cover to be stretched and contracted.

The apparatus may further include a housing coupled to one side of the internal cover, and the housing accommodates at least a portion of the external cover when the external cover is contracted. In one form, the driving unit is installed in the housing.

The external cover may include at least one cover member, and the internal cover and the cover member may be formed of a transparent material such that the sensor may sense while the sensing surface of the sensor is covered.

The external cover may include a cover member, and an inner diameter or an inner width of the cover member may be the same as an outer diameter or an outer width of the internal cover, and the cover member may be stretched and contracted or to slide along the external surface of the internal cover while being in contact with the internal cover.

The cover member may include a first engagement step formed outwardly on an external surface of one side of the cover member. The first engagement step may be selectively caught by and fixed to an engagement end of the housing. In one form, a pusher installed outwardly may be provided on an external surface of the other side of the cover member.

The external cover may include a plurality of cover members, and the cover members may have different cross-sectional areas such that the external cover may have a telescopic structure.

The external cover may include a first cover member most adjacent to the internal cover, and a second cover member most adjacent to the housing.

An inner diameter or an inner width of the first cover member may be the same as an outer diameter or an outer width of the internal cover, and the first cover member may slide along an external surface of the internal cover while being in contact with the internal cover. The first cover member may include a first engagement step formed outwardly on an external surface of one side of the first cover member, and a pusher installed outwardly may be provided on an external surface of the other side of the first cover member.

The external cover may further include at least one third cover member connected between the first cover member and the second cover member. The third cover member may include a first engagement step formed outwardly on an external surface of one side of the third cover member, and a second engagement step formed inwardly on an internal surface of the other side of the third cover member.

The second cover member may include a first engagement step formed outwardly on an external surface of one side of the second cover member, and the first engagement step of the second cover member may be selectively caught by and fixed to an engagement end of the housing. In another form, the second cover member may include a second engagement step formed inwardly on an internal surface of the other side of the second cover member, and the second engagement step of the second cover member may be selectively caught by and fixed to the first engagement step of the first cover member or the first engagement step of the third cover member.

The housing may include an external cover accommodation part selectively accommodating the external cover, and a driving unit accommodation part which includes the driving unit embedded therein or accommodates the driving unit.

The external cover accommodation part may include a bent plate formed in a ring shape and configured to be bent, the bent plate may be coupled to a flange of the internal cover such that an accommodation space may be formed between the bent plate and the internal cover, and a gap may be formed between a radial internal edge of the bent plate forming the engagement end of the housing and an external surface of the internal cover, at a predetermined distance.

The apparatus may further include a cleaning solution accommodated in the external cover accommodation part, and the external cover contracted in the external cover accommodation part may be immersed in the cleaning solution.

The driving unit may include a driver for providing driving force to allow the external cover to be stretched and contracted, and a strip having one side connected to the pusher of the external cover and the other side connected to the driver.

The driver may include a motor configured to rotate forwards and in reverse, a first gear may be mounted on, formed on or connected to a rotation shaft of the motor, and a second gear engaged with the first gear may be formed on a surface of the strip.

The apparatus may further include a control unit electrically connected to the driver to control the driver, and the control unit may be electrically connected to the sensor, may sense transparency of the external cover or the internal cover by the sensor, and may control operations of the driver according to a result of the sensing.

The driving unit accommodation part may include a hollow portion therein and an opening formed on one side surface thereof, and the opening may limit a movement path of the pusher of the external cover connected to the strip.

The apparatus may further include a return means configured to maintain the external cover to be in a stretched state or to allow the external cover to return to a stretched state, and one side of the return means may be fixed to the pusher of the external cover, and the other side may be fixed to the housing.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a perspective diagram illustrating an apparatus for protecting a sensor according to an embodiment of the present disclosure;

FIG. 2 is an exploded perspective diagram illustrating an apparatus for protecting a sensor according to an embodiment of the present disclosure;

FIG. 3 is a cross-sectional diagram illustrating an apparatus for protecting a sensor and an enlarged diagram illustrating a portion of the apparatus according to an embodiment of the present disclosure;

FIG. 4 is a diagram illustrating a connection relationship between a cover member of an external cover and a driving unit of an apparatus for protecting a sensor according to an embodiment of the present disclosure;

FIG. 5 is a diagram illustrating operations of an external cover and a driving unit of an apparatus for protecting a sensor according to an embodiment of the present disclosure; and

FIGS. 6A to 6D are diagrams illustrating a protecting function and a cleaning function of an apparatus for protecting a sensor according to an embodiment of the present disclosure.

### DETAILED DESCRIPTION

Hereinafter, embodiments of the present disclosure are described with reference to the attached drawings. Elements having the same function in the scope of the same concept represented in the drawings of each embodiment are described using the same reference numeral.

The terms “first,” “second,” and the like may be used to distinguish one element from the other, and may not limit a sequence and/or an importance, or others, in relation to the elements. In some cases, a first element may be referred to as a second element, and similarly, a second element may be referred to as a first element without departing from the scope of right of the embodiments.

When a component, device, element, or the like of the present disclosure is described as having a purpose or performing an operation, function, or the like, the component, device, or element should be considered herein as being “configured to” meet that purpose or to perform that operation or function.

In some embodiments described below, the apparatus for protecting a sensor of the present disclosure is installed in a vehicle, but the present disclosure is not limited to the described embodiments.

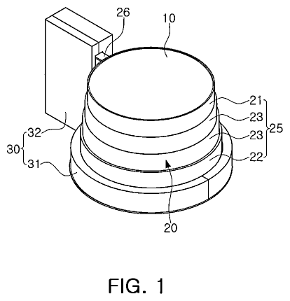

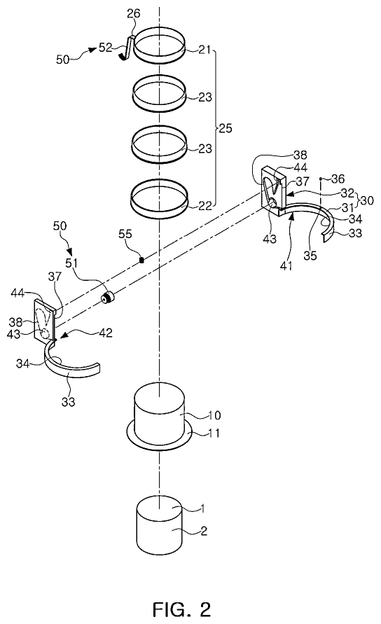

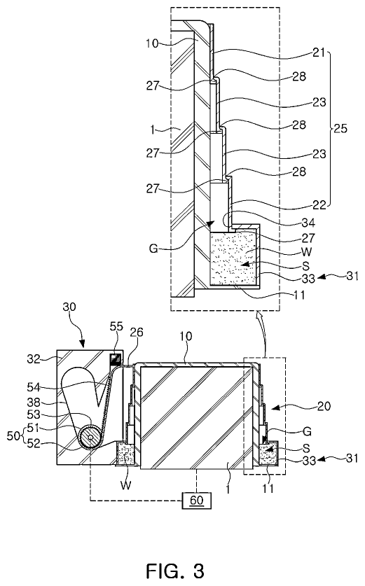

FIG. 1 is a perspective diagram illustrating an apparatus for protecting a sensor according to an embodiment. FIG. 2 is an exploded perspective diagram illustrating an apparatus for protecting a sensor according to an embodiment. FIG. 3 is a cross-sectional diagram illustrating an apparatus for protecting a sensor and an enlarged diagram illustrating a portion of the apparatus according to an embodiment.

As illustrated in the drawings above, the apparatus for protecting a sensor according to an embodiment may include an internal cover 10, an external cover 20, and a driving unit 50.

The internal cover 10 may be a member having a cylindrical shape and may have one side having an open surface. The internal cover may act as a fixed cover covering a sensor 1. In other words, the sensor may be at least partially accommodated in the internal cover.

The internal cover 10 may be formed of a transparent material for the sensor to sense while covering the sensing surface 2 of the sensor 1, and may have a cross-sectional shape corresponding to the sensor. For example, when the sensor has a cylindrical shape, the internal cover may be formed in a cylindrical shape, and when the sensor has a polygonal prism shape, the internal cover may be formed in the shape of a barrel having a corresponding polygonal cross-section.

In the drawing, an example is shown in which the internal cover 10, the external cover 20, and the housing 30 of the apparatus for protecting a sensor in the embodiment may have a circular cross-section to almost correspond to the sensor having a cylindrical shape. However, the shapes of the sensor and the internal cover are not necessarily limited to the above-described and illustrated examples.

Also, the internal cover 10 may be formed of, for example, a transparent synthetic resin, such as polyethylene terephthalate (PET), polyethylene (PE), and polyurethane (PU).

When the apparatus for protecting a sensor according to an embodiment is applied to protect an optical sensor such as a lidar, for example, the internal cover 10 may be formed of a transparent material.

Here, transparency in the embodiment may indicate that, in addition to transmission of light such as visible light, infrared light, laser, or the like, electromagnetic waves required for sensing may also pass through without reflection or scattering.

The open surface of the internal cover 10 may include a flange 11 along an open end. Such a flange may be fixed and coupled to the housing 30 by snap-fit fastening, screw fastening, or bonding. Accordingly, the internal cover and the housing may be coupled to each other.

The external cover 20 may surround the internal cover and may operate along the external side of the internal cover to be stretched and contracted. This external cover may act as a movable cover selectively surrounding the sensor 1 and the internal cover.

To this end, the external cover 20 may include at least one cover member 25. The cover member 25 may be formed as a substantially tubular member.

The cover member 25 may be formed of a transparent material for the sensor to sense while partially covering the sensing surface 2 of the sensor 1, and may have a cross-sectional shape corresponding to the sensor. For example, when the sensor has a cylindrical shape, the cover member may be formed as a tubular member having a circular cross-section, and when the sensor has a polygonal prism shape, the cover member may be formed as a tubular member having a corresponding polygonal cross-section.

Also, the cover member 25 may be formed of, for example, transparent synthetic resins such as polyethylene terephthalate (PET), polyethylene (PE), acrylonitrile-butadiene-styrene copolymer (ABS), or the like.

When the apparatus for protecting a sensor according to an embodiment is applied to protect an optical sensor such as a lidar, for example, the cover member 25 of the external cover 20 may be formed of a transparent material.

At least one cover member 25 may be formed and arranged to partially surround the internal cover 10.

In the apparatus for protecting a sensor according to an embodiment, when the external cover 20 has only one cover member 25, the cover member may be formed and arranged to at least partially surround the internal cover 10 and to be connected to the housing 30 on one side.

In this case, the single cover member 25 itself may be formed to be stretchable. For example, the cover member may be in the form of a corrugated pipe or bellows, and the cover member may be selectively accommodated in the housing 30.

To this end, an inner diameter or an inner width of the cover member 25 may be almost equal to an outer diameter or an outer width of the internal cover 10. Accordingly, the cover member may be stretched and contracted or may slide along the external surface of the internal cover while being in contact with the internal cover.

The cover member 25 may have a first engagement step 27 formed outwardly on an external surface of one side. The first engagement step 27 of the cover member may be selectively caught by and fixed to an engagement end 34 of the housing 30.

Also, a pusher 26 installed outwardly may be provided on the external surface of the other side of the cover member to induce movement of the cover member and to prevent the cover member from being completely accommodated in the housing 30.

In another embodiment form, the cover member 25 may further include a second engagement step 28 formed inwardly on the internal surface of the other side. In this embodiment, the second engagement step 28 of the cover member 25 may be in contact with the internal cover 10, and may slide on the external surface of the internal cover along the guide of the second engagement step.

However, when only the first engagement step 27 is formed on the cover member 25, the area in which the cover member is in contact with the internal cover 10 may be greater than the area in which the second engagement step 28 formed on the cover member is in contact with the internal cover 10. Further, when only the first engagement step 27 is formed on the cover member, the spacing between the cover member and the internal cover may be reduced further than the example in which the second engagement step is in contact with the internal cover.

In the apparatus for protecting a sensor according to an embodiment, when the external cover 20 includes a plurality of cover members 25, the cover members may have different cross-sectional areas. For example, when a plurality of cover members overlap between the internal cover and the housing 30, a cover member radially adjacent to the internal cover may have a cross-sectional area smaller than that of a cover member radially adjacent to the housing.

For example, the external cover 20 may have a telescopic structure. By the operation of the driving unit 50 connected to the external cover, the external cover may be contracted or stretched along the external surface of the internal cover 10.

The cover member most adjacent to the internal cover may be referred to as a first cover member 21, and the cover member most adjacent to the housing 30 may be referred to as a second cover member 22. Selectively, a cover member may be connected between the first cover member and the second cover member, and this cover member may be referred to as a third cover member 23.

In the embodiments and drawings, the first cover member 21 to the third cover member 23 may also be collectively referred to as the cover member 25.

The first cover member 21 may be formed and arranged to partially surround the internal cover 10. The first cover member may be selectively accommodated in the housing 30, the second cover member 22, and the third cover member 23.

To this end, an inner diameter or an inner width of the first cover member 21 may be substantially the same as an outer diameter or an outer width of the internal cover 10. Accordingly, the first cover member may slide along the external surface of the internal cover while being in contact with the internal cover.

The first cover member 21 may have a first engagement step 27 formed outwardly on an external surface of one side. Also, a pusher 26 installed outwardly to prevent the first cover member from being completely accommodated in the other cover member or the housing 30 may be provided on the external surface of the other side of the first cover member.

In one embodiment, the first cover member 21 may further include a second engagement step 28 formed inwardly on the internal surface of the other side. In this case, in the first cover member, the second engagement step may be in contact with the internal cover 10, and may slide on the external surface of the internal cover along the guide of the second engagement step.

However, when only the first engagement step 27 is formed on the first cover member 21, the area in which the first cover member is in contact with the internal cover 10 may be greater than the area in which the second engagement step formed on the first cover member is in contact with the internal cover. Further, when only the first engagement step is formed on the first cover member, the spacing between the first cover member and the internal cover may be reduced further than the example in which the second engagement step is in contact with the internal cover.

The second cover member 22 may be formed and arranged to partially surround the internal cover 10, to be connected to the housing 30 on one side, and to be connected to the first cover member 21 or the third cover member 23 on the other side. The second cover member may selectively accommodate the first cover member and/or the third cover member and may be accommodated in the housing.

The inner diameter or inner width of the second cover member 22 may be relatively larger than the outer diameter or outer width of the first cover member 21 or the third cover member 23. Accordingly, the second cover member may slide relative to the first cover member or the third cover member while being in contact with the first cover member or the third cover member.

The second cover member 22 may have a first engagement step 27 formed outwardly on an external surface of one side. Also, a second engagement step 28 may be formed inwardly on the internal surface of the other side of the second cover member to prevent the first cover member 21 or the third cover member 23 from being separated.

The first engagement step 27 of the second cover member 22 may be selectively caught by and fixed to an engagement end 34 of the housing 30.

The second engagement step 28 of the second cover member 22 may be selectively caught by the first engagement step 27 of the first cover member 21 or the third cover member 23, and may prevent the first cover member or the third cover member and the second cover member from moving relatively by a predetermined distance or more and from being separated from each other.

In this case, the first engagement step 27 of the first cover member 21 or the third cover member 23 may be in contact with the second cover member 22, and the first cover member or the third cover member may slide on the internal surface of the second cover member along the guide of the first engagement step.

Similarly, the second engagement step 28 of the second cover member 22 may be in contact with the first cover member 21 or the third cover member 23, and the second cover member may slide on the external surface of the first cover member or the third cover member along the guide of the second engagement step.

Also, at least one third cover member 23 may be provided between the first cover member 21 and the second cover member 22. The first to third cover members may have different cross-sectional areas, but may have the same cross-sectional shape.

Specifically, in the case of the plurality of cover members, the size of the cross-sectional area of the second cover member 22 may be larger than the size of the cross-sectional area of the third cover member 23, and the size of the cross-sectional area of the first cover member 21 may be smaller than the size of the cross-sectional area of the third cover member 23.

Each third cover member 23 may have a first engagement step 27 formed outwardly on an external surface of one side. Also, the second engagement step 28 may be formed inwardly on the internal surface of the other side of each third cover member.

When only one third cover member 23 is provided, the first engagement step 27 of the third cover member may be selectively caught by and fixed to the second engagement step 28 of the second cover member 22. Also, the second engagement step 28 of the third cover member may be selectively caught by and fixed to the first engagement step 27 of the first cover member 21.

Accordingly, the first cover member 21 to the third cover member 23 may be prevented from moving relatively by a predetermined distance or more and from being separated from each other.

When a plurality of third cover members 23 are provided, the size of the cross-sectional area of the third cover member relatively adjacent to the housing 30 may be larger than the cross-sectional area of the third cover member relatively adjacent to the internal cover 10.

Also, the first engagement step 27 of the third cover member 23 relatively adjacent to the internal cover 10 may be selectively caught by and fixed to the second engagement step 28 of the third cover member 23 relatively adjacent to the housing 30.

Accordingly, the third cover members 23 may be prevented from moving relatively by a predetermined distance or more, and from being separated from each other.

Accordingly, the apparatus for protecting a sensor according to an embodiment may cover and protect the sensing surface 2 of the sensor 1 by both the external cover 20 and the internal cover 10 and may prevent foreign substances from being directly attached to the sensing surface of the sensor, thereby preventing contamination.

Also, the apparatus for protecting a sensor according to an embodiment may include a housing 30 coupled to one side of the internal cover 10. The housing 30 accommodates an external cover when the external cover 20 is contracted, and including a driving unit 50 installed therein.

The housing 30 may be a member substantially having an L-shape, and may include an external cover accommodation part 31 for selectively accommodating the external cover 20, and a driving unit accommodation part 32 embedded with or accommodating the driving unit 50. The housing may be fixed and installed to an installation object (not illustrated).

The installation object may be, for example, a vehicle body, and the housing 30 may be fixed and installed to the installation object by a fastener such as a screw or an adhesive. The method of installing the housing 30 is not limited to the above-described example, and any other method may be applied.

The housing 30 may be formed and arranged to partially surround the sensor 1 and to accommodate the components of the driving unit 50 therein. The sensor may be connected to an external power source by a wire (not illustrated) and may be supplied with electricity.

The external cover accommodation part 31 may be formed as a bent plate 33 formed in a ring shape and bent to have a cross-section substantially having an inverted L-shape. As the bent plate of the external cover accommodation part is at least watertight-coupled to the flange 11 of the internal cover 10, the external cover accommodation part may form a predetermined accommodation space S between the bent plate and the internal cover.

Here, a gap G may be formed between a radial internal edge of the bent plate 33 forming the engagement end 34 of the housing 30 and the external surface of the internal cover by a predetermined distance. At least one cover member 25 forming the external cover 20 may be inserted into the gap and may be accommodated in the external cover accommodation part 31 of the housing.

By the operation of the driving unit 50 installed in the external cover accommodation part 31 and connected to the external cover 20, the external cover may be contracted into or stretched from the housing 30 along the external surface of the internal cover 10 through the gap G between the bent plate 33 and the internal cover 10.

When the external cover 20 includes a plurality of cover members 25, the cover members having different cross-sectional areas may overlap each other and may be inserted into the gap G between the bent plate 33 and the internal cover 10. Accordingly, the plurality of cover members may be accommodated in the external cover accommodation part 31 of the housing 30 while overlapping each other.

Also, the apparatus for protecting a sensor according to an embodiment may further include a cleaning solution W accommodated in the external cover accommodation part 31 of the housing 30. Specifically, the cleaning solution may be accommodated in the accommodation space S between the internal cover 10 and the bent plate 33 forming the external cover accommodation part 31.

In one embodiment, a sealing member (not illustrated) may be applied between the bent plate 33 and the internal cover 10 for watertight coupling between the bent plate and the internal cover.

Also, in the external cover accommodation part 31 of the housing 30, for example, the bent plate 33 may include an inlet port 35 for supplying and replenishing the cleaning solution W. A cap 36 may be provided in the inlet port and may prevent leakage of the cleaning solution.

Alternatively, for example, when the installation object is a vehicle body, the inlet port 35 may be connected to a washer fluid tank (not illustrated) and a pump of the vehicle via a tube. Accordingly, the apparatus for protecting a sensor according to an embodiment may be supplied with a washer fluid of the vehicle as the cleaning solution W.

As such, the external cover 20 contracted in the external cover accommodation part 31 for accommodating the cleaning solution W, that is, the at least one cover member may be immersed in the cleaning solution and washed.

The driving unit accommodation part 32 may be a member having an almost box shape and including a hollow portion therein and an opening 37 formed on one side thereof. The driving unit accommodation part 32 may be coupled to and disposed in the external cover accommodation part 31 to be supported by an external surface of one side of the external cover accommodation part 31.

For example, an axis of the driving unit accommodation part 32 in a length direction may be arranged to extend in a direction almost perpendicular to a radial axis of the external cover accommodation part 31. Further, an axis of the driving unit accommodation part in a width direction may be arranged to extend parallel to the radial axis of the external cover accommodation part.

This driving unit accommodation part 32 may accommodate, protect and support the components of the driving unit 50 disposed in the hollow portion.

In another embodiment, the housing 30 may be formed to be divided into a first housing part 41 and a second housing part 42. When being divided into the first housing part and the second housing part, the external cover accommodation part 31 and the driving unit accommodation part 32 may also be divided into two components. For example, the first housing part and the second housing part may be separated in a direction perpendicular to the radial axis of the external cover accommodation part, that is, along an axis of the driving unit accommodation part taken in the length direction.

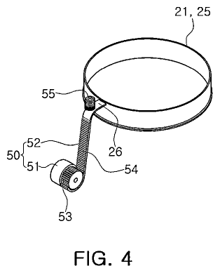

FIG. 4 is a diagram illustrating a connection relationship between a cover member of an external cover and a driving unit of an apparatus for protecting a sensor according to an embodiment.

The driving unit 50 may be installed in the driving unit accommodation part 32 of the housing 30, such that the external cover may be stretched and contracted while the position of the external cover 20 with respect to the sensing surface 2 of the sensor 1 may be maintained. The driving unit may include a driver 51 and a strip 52.

The driver 51 may provide driving force to allow the external cover 20 to be stretched and contracted. As the driver, for example, a motor which may rotate forward and reverse may be employed. Also, when the driver is a motor, a first gear 53 may be mounted, formed, or connected to a rotation shaft of the motor.

The first gear 53 may have teeth formed on a circumferential surface thereof, and the first gear may be directly mounted on the rotation shaft of the driver 51 or teeth may be formed on the rotation shaft. Alternatively, the first gear may be indirectly connected to the rotation shaft of the driver through a transmission means such as another gear.

The driver 51 may be connected to a power source present externally of the housing 30 by a wire (not illustrated) and may receive electricity.

However, the configuration and operation of the driver is not limited to the above-described example. For example, as the driving unit, for example, an actuator having an operation rod which may move backwards and forwards may be employed. In this case, the first gear may not be provided.

For the installation of the driver 51, a seating groove 43 for the driver which may hold and support the driver may be formed on the internal surface of one side and the internal surface of the other side of the housing 30

For example, when the housing 30 is formed to be divided into the first housing part 41 and the second housing part 42, a seating groove 43 for the driving unit may be formed on each of the internal surface of the first housing part and the internal surface of the second housing part included in the driving unit accommodation part 32 as illustrated in the drawings.

The strip 52 may be formed in a shape of a flexible bar having a predetermined length. One side of the strip may be connected to the pusher 26 of the cover member 25 or the first cover member 21, and the other side may be connected to the driver 51.

For example, the strip 52 may be integrated with the pusher 26 of the cover member 25 or the first cover member 21. Alternatively, an end of one side of the strip may be connected to the pusher of the cover member or the first cover member by bolting or bonding.

In the case in which the driver 51 is a motor and the first gear 53 is mounted, formed or connected to the rotation shaft of the motor, a second gear 54 may be formed on the surface of the strip 52. As the first gear of the driver and the second gear of the strip are engaged with each other, driving force of the driver may be transmitted to the cover member 25 or the first cover member 21.

When the driver 51 is an actuator, an end of the other side of the strip 52 may be connected to an actuating rod of an actuator by bolting, clamping or bonding. Accordingly, the driving force of the driving unit may be transmitted to the cover member 25 or the first cover member 21.

Such a strip 52 may be formed of, for example, a synthetic resin such as polyethylene terephthalate (PET), polyethylene (PE), acrylonitrile-butadiene-styrene copolymer (ABS).

Referring to FIGS. 1 to 3, a guide 38 connected to the opening 37 may be provided in the hollow portion of the driving unit accommodation part 32 to guide the movement of the strip 52. Such a guide may be formed by a wall portion of the hollow portion, or may be formed as a partition installed in the hollow portion.

For example, when the housing 30 is formed to be divided into the first housing part 41 and the second housing part 42, a guide 38 may be formed on each of the internal surface of the first housing part and the internal surface of the second housing part included in the driving unit accommodation part 32 as illustrated in the drawings.

The driver 51 may be installed adjacent to the moving path of the strip 52 which may be moved and guided by the guide 38.

For example, when the housing 30 is formed to be divided into the first housing part 41 and the second housing part 42, a seating groove 43 for the driver may be formed adjacent to one side of each guide 38 on the internal surface of the first housing part and the internal surface of the second housing part included in the driving unit accommodation part 32.

Accordingly, the strip 52 connected to the driver 51 from the cover member 25 or the first cover member 21 may be guided by the guide 38 and may move in the driving unit accommodation part 32. For example, as illustrated in the drawings, the strip may move along the guide in an almost S-shape.

The opening 37 of the driving unit accommodation part 32 may limit the movement path of the pusher 26 of the cover member 25 or the first cover member 21 connected to one side of the strip. Specifically, the length of the opening extending along the axis of the driving unit accommodation part in the length direction may be determined to be equal to the stretched or contracted length of the external cover 20.

The apparatus for protecting a sensor according to an embodiment may further include a return means 55 for maintaining the external cover 20 in the stretched state or returning the external cover 20 to be in the stretched state.

The return means 55 may be implemented as, for example, a spring such as a coil spring, but an example embodiment thereof is not limited thereto.

When the return means 55 is a spring, an end of one side of the spring may be fixed to the pusher 26 of the cover member 25 or the first cover member 21 forming the external cover 20, and an end of the other side may be caught by and fixed to the housing 30.

For the installation of the return means 55, a seating groove 44 for the return means for holding and supporting the return means may be formed on the internal surface of one side and the internal surface of the other side of the housing 30.

For example, when the housing 30 is formed to be divided into the first housing part 41 and the second housing part 42, the seating groove 44 for the return means may be formed on each of the internal surface of the first housing part and the internal surface of the second housing part included in the driving unit accommodation part 32 as illustrated in the diagram.

The return means 55 may maintain the stretched state of the cover member 25 of the external cover 20 by elastic force of the spring, and also, when the cover member of the external cover is contracted, restoring force may be accumulated due to tension of the spring, such that, when the driving unit 50 operate to stretch the cover member of the external cover, the cover member may return swiftly with a large force.

Here, the driving force applied by the driver 51 and the strip 52 to stretch and contract the external cover may need to be determined to exceed the restoring force of the return means 55, specifically, the elastic force of the spring.

The apparatus for protecting a sensor according to an embodiment may further include a control unit 60 for controlling the driver 51. The control unit may be electrically connected to the driver and may communicate with the driver in a wired, wireless, or wired/wireless manner.

The control unit 60 may control the driver 51 to operate in a certain period (e.g., 1 to 6 months) or when a certain condition is achieved (when transparency deteriorates) and may pull the strip 52, such that the external cover 20 may be contracted into the external cover accommodation part 31 of the housing 30 and may be washed by the cleaning solution in the external cover accommodation part.

To this end, the control unit 60 may include a timer or may be electrically connected to the timer, for example. Accordingly, when it is determined that a predetermined period has been reached, the control unit may control the operation of the driver 51.

Alternatively, the control unit 60 may be electrically connected to the sensor 1, for example. Accordingly, when there is a foreign substance on the external cover 20 or the internal cover 10, the control unit may recognize abnormality in sensing of the sensor or may analyze the sensed data such that the control unit may sense transparency of the external cover or the internal cover and may measure the contamination level, and may control the operation of the driver 51 according to the result.

However, an example embodiment thereof is not limited thereto, and to control the operation of the driver 51, the apparatus for protecting a sensor may further include a transparency sensor (not illustrated) for sensing transparency of the external cover 20 or the internal cover and the control unit 60 may be electrically connected to the transparency sensor.

As the transparency sensor, for example, an optical sensor, such as an infrared sensor, or a rain sensor may be employed. Specifically, the transparency sensor may detect transparency of the external cover 20 or the internal cover 10, and when it is determined that the transparency of the external cover or the internal cover has deteriorated to be a reference value or more by a signal from the transparency sensor, the control unit 60 may control the operation of the driver 51.

Accordingly, foreign substances may be removed from the surface of the external cover 20 or the internal cover 10, and the external cover may be washed and automatically disposed on the sensing surface 2 of the sensor 1.

When the apparatus for protecting a sensor according to an embodiment is applied to a vehicle, for example, the control unit 60 may be incorporated into or used in combination with an electronic control unit (ECU) of the vehicle.

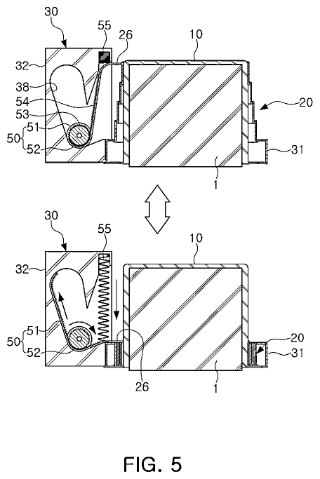

FIG. 5 is a diagram illustrating operations of an external cover and a driving unit of an apparatus for protecting a sensor according to an embodiment. The external cover and the housing are represented in cross-sectional diagrams.

When the external surface of the external cover 20 is contaminated by foreign substances, the driver 51 may rotate alternately in the forward and reverse directions under control of the control unit 60, such that the first gear 53 may rotate and the second gear 54 engaged with the first gear may move, and the strip 52 may move back and forth.

For example, when the external cover 20 is contracted, the first gear 53 may rotate in the forward direction (e.g., a clockwise direction in FIG. 5) by the driving force of the driver 51, and as the second gear 54 engaged with the first gear moves, the strip 52 may move along the guide 38 disposed in the driving unit accommodation part 32 of the housing 30.

In this case, the cover member 25 of the external cover 20 connected to the strip via the pusher 26 may be contracted into and accommodated in the external cover accommodation part 31 of the housing 30 according to the movement of the strip 52.

When the plurality of cover members 25 are included in the external cover 20, the first cover member 21 may move to the external cover accommodation part 31 of the housing 30 according to the movement of the strip 52, and the pusher 26 of the first cover member may apply force to the second cover member 22 and/or the third cover member 23 such that the second cover member and/or the third cover member may move to the external cover accommodation part.

The cover members having different cross-sectional areas may overlap each other and may be inserted into the gap G between the bent plate 33 of the housing 30 and the internal cover 10. Accordingly, the plurality of cover members 25 may be accommodated in the external cover accommodation part 31 of the housing while overlapping each other.

When the external cover 20 is stretched, the first gear 53 may rotate in the reverse direction (e.g., a counterclockwise direction in FIG. 5) by the driving force of the driver 51, and the second gear 54 engaged with the first gear may move in an opposite direction differently from before, such that the strip 52 may move along the guide 38 disposed in the driving unit accommodation part 32 of the housing 30.

In this case, the cover member 25 of the external cover 20 connected to the strip via the pusher 26 may be smoothly drawn out from the external cover accommodation part 31 of the housing 30 by the restoring force of the receiving means along with the movement of the strip according to the movement of the strip 52.

When the plurality of cover members 25 are included in the external cover 20, the first cover member 21 may come out of the external cover accommodation part 31 of the housing 30 according to the movement of the strip 52 and the cooperation of the return means 55, and the first engagement step 27 of the first cover member may be caught by and fixed to the second engagement step 28 of the second cover member 22 and/or the third cover member 23 such that the second cover member 22 and/or the third cover member 23 may also be drawn out from the external cover accommodation part.

As the first engagement step 27 of the cover member 25 or the second cover member 22 is caught by and fixed to the engagement end 34 of the housing 30, the cover member(s) may be prevented from being separated from the housing.

The external cover 20 may be fully stretched and may surround the internal cover 10 and the sensing surface 2 of the sensor 1. The cover member 25 of the external cover may be maintained in a stretched state by the return means 55.

While the external cover 20 is contracted or stretched as above, a relatively large foreign substance may be removed from the contaminated portion of the external cover 20 or the internal cover 10 by the cover member 25.

Thereafter, foreign substances having great viscosity and having a relatively small size or thin thickness, remaining in the contaminated portion of the external cover 20, may be washed by the cleaning solution W provided in the external cover accommodation part 31 of the housing 30.

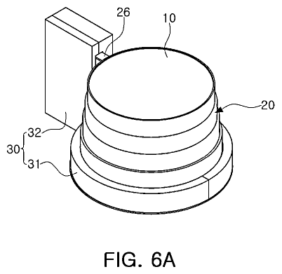

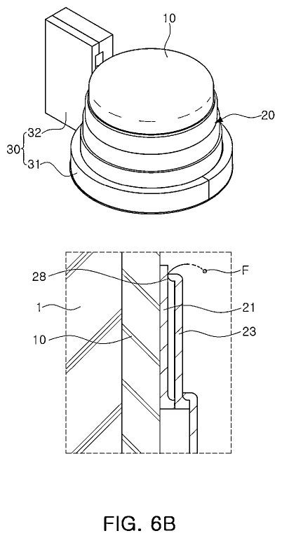

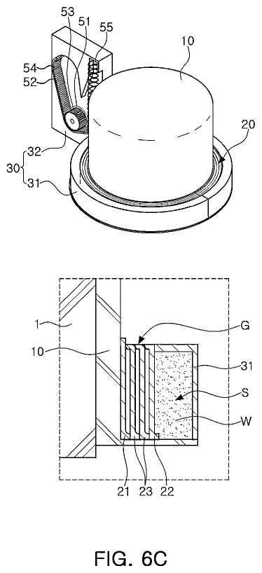

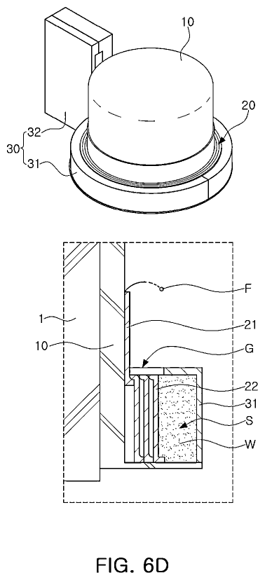

FIGS. 6A to 6D are diagrams illustrating a protecting function and a cleaning function of an apparatus for protecting a sensor according to an embodiment.

Referring to FIG. 6A, the internal cover 10 may cover a sensor 1 and may cover the sensing surface 2 of the sensor. Accordingly, the internal cover may prevent foreign substances from being directly attached to the sensor.

Also, the external cover 20 may surround the internal cover 10, and may be disposed in a stretched state along an external side of the internal cover. Accordingly, the external cover may prevent foreign substances from being attached to the internal cover.

The apparatus for protecting a sensor according to an embodiment configured as described above may cover and protect the sensing surface 2 of the sensor 1 by both the external cover 20 and the internal cover 10, and may prevent foreign substances from being directly attached to the sensing surface of the sensor, which may be advantageous.

Referring to FIG. 6B, when the foreign substance F is attached to the external cover, the control unit 60 may recognize, for example, abnormality in sensing of the sensor 1 or may analyze the sensed data such that the control unit 60 may sense transparency of the external cover 20 and may measure a contamination level, and may control operations of the driver 51.

The first gear 53 may rotate in the forward direction by the driving force of the driver 51, and the second gear 54 engaged with the first gear may move such that the strip 52 may move along the guide 38 provided in the driving unit accommodation part 32 of the housing 30.

As the strip 52 moves, the cover member 25 or the first cover member 21 of the external cover 20 connected to the strip may be contracted toward the external cover accommodation part 31 of the housing 30.

In this case, the foreign substance F may also move together according to the movement of the cover member 25 or the first cover member 25, and the foreign substance may gradually approach the engagement end 34 of the external cover accommodation part 31 or the second engagement step 28 of the other cover member. A relatively large foreign substance may be removed from the external cover 20 by the engagement end or the second engagement step.

When the external cover 20 includes a plurality of cover members 25, the surface of the cover member radially adjacent to the internal cover 10 may be wiped by the cover member radially adjacent to the housing 30.

Referring to FIG. 6c, the cover member 25, the first cover member 21 and the second cover member 22, or the first cover member 21 to the third cover member 23 of the external cover 20 connected to the strip may be contracted into and accommodated in the external cover accommodation part 31 of the housing 30 according to the movement of the strip 52.

In the external cover, the portion from which foreign substance F has been removed but in which a trace or contamination still remains may be sufficiently immersed in the cleaning solution W contained in the external cover accommodation part 31.

Accordingly, foreign substances having great viscosity and a relatively small size or thin thickness, remaining in the contaminated portion of the external cover 20, may be washed by the cleaning solution W contained in the external cover accommodation part 31 for a short period of time.

During this time, a clean portion of the internal cover 10 exposed from the external cover 20 may form an exposed surface corresponding to the sensing surface 2 of the sensor 1.

Accordingly, the apparatus for protecting a sensor according to an embodiment may protect the sensor by the internal cover 10 without stopping the operation of the sensor 1 while the external cover 20 is washed.

Referring to FIG. 6D, the driver 51 may operate in the opposite direction differently from before and the first gear 53 may rotate in the reverse direction under control of the control unit 60. The second gear 54 engaged with the first gear may also move in the opposite direction differently from before such that the strip 52 moves along the guide 38 disposed in the driving unit accommodation part 32 of the housing 30.

As the strip 52 moves, the cover member 25 of the external cover 20 connected to the strip may start being drawn out from the external cover accommodation part 31 of the housing 30 by the restoring force of the return means 55 along with the movement of the strip.

When the external cover 20 includes a plurality of cover members 25, starting from the first cover member 21, the other cover members may be drawn out from the external cover accommodation part 31 in sequence depending on the degree of radial proximity to the internal cover 10.

In this case, when a foreign substance F is attached to the internal cover 10 exposed while the external cover 20 is washed, the foreign substance may be removed from the internal cover by an edge of the cover member 25 or the first cover member 21 sliding along the external surface of the internal cover.

In other words, the surface of the internal cover 10 may be wiped by the cover member 25 forming the external cover 20.

Further, by the restoring force of the return means 55, the cover member 25 of the external cover 20 may move swiftly by the weighted force, such that foreign substances on the internal cover 10 may be easily removed.

The cleaned and washed portion of the external cover 20 may be drawn out from the cleaning solution W of the housing 30, may be disposed to correspond to the sensing surface 2 of the sensor 1, and may form an exposed surface.

This process may be performed at least once or more. Accordingly, the sensor 1 may continuously and accurately sense through the external cover 20 or the internal cover 10.

According to the apparatus for protecting a sensor according to an embodiment, the apparatus may be configured compactly because a pump and connection pipe for spraying air or water, a wiper to wipe, and the like are not used, and accordingly, costs may be reduced, and space required in an installation object, such as a vehicle, may be greatly reduced.

Also, using the apparatus for protecting a sensor according to an embodiment, the double cover surrounds the sensing surface of the sensor, and one of the covers is configured to be stretched and contracted, such that the sensor and also the installation object and environment may be prevented from being contaminated. Even when contamination by foreign substances occurs, the covers may be easily and cleanly washed, and the sensing may be continuously performed without interruption.

Further, using the apparatus for protecting a sensor according to an embodiment, a two-step system in which large-sized foreign substances may be removed by the double cover itself, and foreign substances having great viscosity and a small size may be washed with a cleaning solution may be applied, such that foreign substances may be reliably removed in a short period of time. It may not be necessary to periodically supply the cleaning solution, and the apparatus may be used semi-permanently.

The above description is merely an example of the technical idea of the present disclosure, and various modifications and variations may be made without departing from the scope of the present disclosure by those having ordinary skill in the art to which the present disclosure pertains.

For example, the cover member formed in the form of a corrugated pipe or bellows may be applied to at least one of the first cover member, the second cover member or the third cover member.

While the embodiments have been illustrated and described above, it should be apparent to those having ordinary skill in the art that modifications and variations thereof could be made without departing from the scope of the present disclosure.

What is claimed is:

1. An apparatus for protecting a sensor, comprising:
an internal cover covering a sensor;
an external cover surrounding the internal cover and configured to be stretched and contracted along an external side of the internal cover; and
a driving unit connected to the external cover and configured to allow the external cover to be stretched and contracted.

2. The apparatus of claim 1, further comprising:
a housing coupled to a first side of the internal cover and configured to accommodate at least a portion of the external cover when the external cover is contracted, wherein the driving unit is installed in the housing.

3. The apparatus of claim 2,
wherein the external cover includes at least one cover member, and
wherein the internal cover and the cover member are formed of a transparent material such that the sensor is able to sense while the sensing surface of the sensor is covered.

4. The apparatus of claim 3,
wherein the external cover includes a cover member, and
wherein an inner diameter or an inner width of the cover member is the same as an outer diameter or an outer width of the internal cover, and the cover member is configured to be stretched and contracted or to slide along the external surface of the internal cover while being in contact with the internal cover.

5. The apparatus of claim 4,
wherein the cover member includes a first engagement step formed outwardly on an external surface of a first side of the cover member, and the first engagement step is selectively caught by and fixed to an engagement end of the housing, and
wherein a pusher installed outwardly is provided on an external surface of a second side of the cover member.

6. The apparatus of claim 3,
wherein the external cover includes a plurality of cover members, and
wherein the cover members have different cross-sectional areas such that the external cover has a telescopic structure.

7. The apparatus of claim 6, wherein the external cover includes:
a first cover member most adjacent to the internal cover; and
a second cover member most adjacent to the housing.

8. The apparatus of claim 7, wherein
wherein an inner diameter or an inner width of the first cover member is the same as an outer diameter or an outer width of the internal cover, and the first cover member is configured to slide along an external surface of the internal cover while being in contact with the internal cover,
wherein the first cover member includes a first engagement step formed outwardly on an external surface of a first side thereof, and
wherein a pusher installed outwardly is provided on an external surface of a second side of the first cover member.

9. The apparatus of claim 8,
wherein the external cover further includes at least one third cover member connected between the first cover member and the second cover member,
wherein the third cover member includes:
a first engagement step formed outwardly on an external surface of a first side of the third cover member; and
a second engagement step formed inwardly on an internal surface of a second side of the third cover member.

10. The apparatus of claim 9,
wherein the second cover member includes a first engagement step formed outwardly on an external surface of a first side of the second cover member, and the first engagement step of the second cover member is selectively caught by and fixed to an engagement end of the housing, and
wherein the second cover member includes a second engagement step formed inwardly on an internal surface of a second side of the second cover member, and the second engagement step of the second cover member is selectively caught by and fixed to the first engagement step of the first cover member or the first engagement step of the third cover member.

11. The apparatus of claim 2, wherein the housing includes:
an external cover accommodation part selectively accommodating the external cover; and
a driving unit accommodation part configured to accommodate the driving unit.

12. The apparatus of claim 11,
wherein the external cover accommodation part includes a bent plate having a ring shape and configured to be bent,
wherein the bent plate is coupled to a flange of the internal cover such that an accommodation space is formed between the bent plate and the internal cover, and
wherein a gap is formed between a radial internal edge of the bent plate forming an engagement end of the housing and an external surface of the internal cover, at a predetermined distance.

13. The apparatus of claim 11, further comprising:
a cleaning solution accommodated in the external cover accommodation part,
wherein the external cover contracted in the external cover accommodation part is immersed in the cleaning solution.

14. The apparatus of claim 11, wherein the driving unit includes:
a driver configured to provide a driving force to allow the external cover to be stretched and contracted; and
a strip having a first side connected to a pusher of the external cover and a second side connected to the driver.

15. The apparatus of claim 14,
wherein the driver includes a motor configured to rotate,
wherein a first gear is mounted on, formed on or connected to a rotation shaft of the motor, and
wherein a second gear engaged with the first gear is formed on a surface of the strip.

16. The apparatus of claim 14, further comprising:
a control unit electrically connected to the driver to control the driver,
wherein the control unit is electrically connected to the sensor, and configured to:
determine transparency of the external cover or the internal cover using the sensor, and
control an operation of the driver according to a determined transparency of the external cover or the internal cover.

17. The apparatus of claim 14,
wherein the driving unit accommodation part includes a hollow portion therein and an opening formed on a first side surface of the driving unit accommodation part, and
wherein the opening is configured to limit a movement path of the pusher of the external cover connected to the strip.

18. The apparatus of claim 2, further comprising:
a return means configured to maintain the external cover to be in a stretched state or to allow the external cover to return to the stretched state,
wherein a first side of the return means is fixed to a pusher of the external cover, and a second side of the return means is fixed to the housing.
